(19) United States
(12) Patent Application Publication
(10) Pub. No.: US 2021/0231860 A1
(43) Pub. Date: Jul. 29, 2021

(54) LIGHT GUIDE PLATE, BACKLIGHT MODULE AND DISPLAY DEVICE

(71) Applicants: Beijing BOE Technology Development Co., Ltd., Beijing (CN); BOE Technology Group Co., Ltd., Beijing (CN)

(72) Inventors: Yongda MA, Beijing (CN); Xinyin WU, Beijing (CN); Yong QIAO, Beijing (CN); Jianbo XIAN, Beijing (CN); Pan LI, Beijing (CN)

(21) Appl. No.: 16/649,167

(22) PCT Filed: Sep. 25, 2019
(86) PCT No.: PCT/CN2019/107914

§ 371 Date: Mar. 20, 2020

(30) Foreign Application Priority Data
Sep. 29, 2018 (CN) 201821610636.8

(51) Int. Cl. F21V 8/00

(52) U.S. Cl. CPC G02B 6/0036; G02B 6/0045; G02B 6/0086; G02B 6/0055

(57) ABSTRACT

A light guide plate, a backlight module and a display device. The light guide plate includes: a light guide plate substrate, prisms and lattice points, the light guide plate substrate includes: a light emitting surface and a lattice surface opposite to light emitting surface; the prisms are located on light emitting surface of the light guide plate substrate; the lattice points are located on the lattice surface of the light guide plate substrate; and orthographic projections of the lattice points on light emitting surface of the light guide plate substrate and orthographic projections of the prisms on the light emitting surface of the light guide plate substrate are overlapped; the maximum widths of the lattice points are less than 1.5 times spans of the prisms; and the spans are equal to lengths of bottom edges of sides, close to the light guide plate substrate, of main sections of the prisms.

### CROSS REFERENCE TO RELATED APPLICATIONS

The present disclosure is a National Stage of International Application No. PCT/CN2019/107914, filed on Sep. 25, 2019, which claims the priority of a Chinese patent application No. 201821610636.8, submitted to the Chinese Patent Office on Sep. 29, 2018 and entitled “Light Guide Plate, Backlight Module and Display Device”, both of which are hereby incorporated by reference in their entireties.

### FIELD

The present disclosure relates to the technical field of display, in particular to a light guide plate, a backlight module and a display device.

### BACKGROUND

With the development of a liquid crystal display (LCD) technology, more and more products made of liquid crystal display panels are produced, such as mobile phones, TVs, computers and digital cameras. A backlight module is one of key components of a liquid crystal display product and can convert a point light source or a line light source into a practical surface light source for a display device, and thus a light source required for display is supplied to the display device.

### SUMMARY

An embodiment of the present disclosure provides a light guide plate, including:

a light guide plate substrate provided with a light emitting surface and a lattice surface which are opposite to each other;

a plurality of prisms located on the light emitting surface; and

a plurality of lattice points located on the lattice surface, wherein orthographic projections of the lattice points on the light emitting surface and an orthographic projection of at least one of the prisms on the light emitting surface are overlapped; a maximum width of any one of the lattice points is less than 1.5 times a span of any two adjacent ones of the prisms; and the span is equal to a length of a bottom edge close to the light guide plate substrate, of a main section of any one of the prisms.

In a possible implementation manner, according to the above light guide plate provided by some embodiments of the present disclosure, a maximum width of any one of the lattice points is greater than 0.5 time the spans.

In a possible implementation manner, according to the above light guide plate provided by some embodiments of the present disclosure, the prisms are triangular prisms, and lengths of other two sides of the triangular prisms except bottom edges are equal to each other;

the maximum width satisfies following relational expression:

H/tan α<D<3H/tan α, wherein

D represents the maximum width; H represents a height corresponding to the bottom edge, and α represents a base angle in the main section.

In a possible implementation manner, according to the above light guide plate provided by some embodiments of the present disclosure, the prisms protrude from a surface on the side of the light emitting surface of the light guide plate substrate; and

the lattice points protrude from a surface, on the side of the lattice surface, of the light guide plate substrate.

In a possible implementation manner, according to the above light guide plate provided by some embodiments of the present disclosure, the prisms protrude from a surface, on the side of the light emitting surface, of the light guide plate substrate; and

the lattice points are recessed in a surface, on the side of the lattice surface, of the light guide plate substrate.

In a possible implementation manner, according to the above light guide plate provided by some embodiments of the present disclosure, the prisms are recessed in a surface, of one side of the light emitting surface, of the light guide plate substrate; and

the lattice points protrude from a surface, on the side of the lattice surface, of the light guide plate substrate.

In a possible implementation manner, according to the above light guide plate provided by some embodiments of the present disclosure, the prisms are recessed in a surface, on the side of the light emitting surface, of the light guide plate substrate; and the lattice points are recessed in a surface, on the side of the lattice surface, of the light guide plate substrate.

In a possible implementation manner, according to the light guide plate provided by some embodiments of the present disclosure, the plurality of the lattice points are arranged in an array; and

any one of the prisms corresponds to a row or a column of the lattice points.

In a possible implementation manner, according to the light guide plate provided by some embodiments of the present disclosure, the lattice points are circular, oval or polygonal.

An embodiment of the present disclosure provides a backlight module including the above light guide plate.

In a possible implementation manner, the above backlight module provided by some embodiments of the present disclosure further includes: a light source located on a side surface of the light guide plate, and a reflection plate located on the side of the lattice surface of the light guide plate.

In a possible implementation manner, the above backlight module provided by some embodiments of the present disclosure further includes: a back plate frame located on the side of the light emitting surface of the light guide plate, and a back plate located on one side of the lattice surface of the light guide plate;

an orthographic projection of the edge, on the light emitting surface of the light guide plate, of the back plate frame on the light emitting surface of the light guide plate overlaps with orthographic projections of the prisms on the light emitting surface of the light guide plate.

In a possible implementation manner, according to the above backlight module provided by some embodiments of the present disclosure, orthographic projections of the lattice points of the lattice surface on the light emitting surface of the light guide plate overlap with the orthographic projection of the edge, on the light emitting surface of the light guide plate, of the back plate frame on the light emitting surface of the light guide plate.

In a possible implementation manner, according to the above backlight module provided by some embodiments of the present disclosure, orthographic projections of at least two rows of lattice points of the lattice surface on the light emitting surface of the light guide plate overlap with the orthographic projection of the edge, on the light emitting surface of the light guide plate, of the back plate frame on the light emitting surface of the light guide plate.

An embodiment of the present disclosure provides a display device including the above backlight module.

In a possible implementation manner, the above display device provided by some embodiments of the present disclosure further includes: a display panel located on the side of the light emitting surface of the light guide plate.

### BRIEF DESCRIPTION OF THE DRAWINGS

FIGS. 1 to 4 are schematic structural diagrams of a light guide plate provided by an embodiment of the present disclosure;

FIG. 5 is a schematic top view of a light guide plate provided by an embodiment of the present disclosure; and

FIG. 6 is a schematic structural diagram of a display device provided by an embodiment of the present disclosure.

### DETAILED DESCRIPTION OF THE EMBODIMENTS

In the related art, a backlight module generally includes a light guide plate, prisms are integrated on one surface of the light guide plate, and lattice points are integrated on the other surface of the light guide plate. However, due to improper cooperation between the prisms and the lattice points on the light guide plate, it is liable to cause poor uniformity of emergent light of the backlight module, resulting in poor uniformity of a display image.

Aiming at the problem of poor uniformity of emergent light of the backlight module in the related art, the embodiments of the present disclosure provide a light guide plate, a backlight module and a display device.

Hereinafter, specific implementations of the light guide plate, the backlight module and the display device according to the embodiments of the present disclosure will be described in detail with reference to accompanying drawings. The thicknesses and shapes of film layers in the accompanying drawings do not reflect the true scale, and are only used to illustrate the present disclosure.

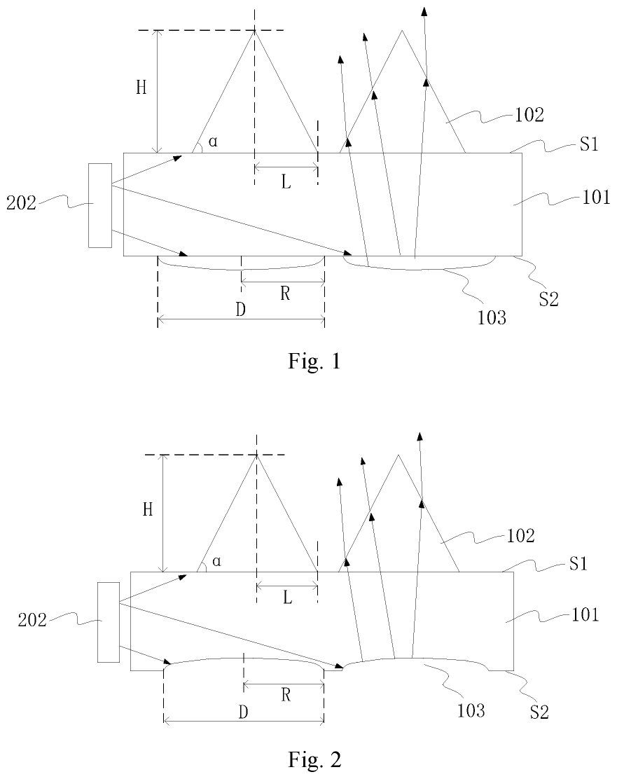

The present disclosure provides a light guide plate, as shown in FIGS. 1 to 4, including:

a light guide plate substrate 101, including a light emitting surface S1 and a lattice surface S2 opposite to the light emitting surface S1, that is, the light guide plate substrate 101 provided with the light emitting surface S1 and the lattice surface S2 which are opposite;

a plurality of prisms 102 located on the light emitting surface S1 of the light guide plate substrate 101;

a plurality of lattice points 103 located on the lattice surface S2 of the light guide plate substrate 101, wherein

orthographic projections of the lattice points 103 on the light emitting surface S1 of the light guide plate substrate 101 and orthographic projections of the prisms on the light emitting surface S1 of the light guide plate substrate 101 are overlapped; the maximum widths of the lattice points 103 are less than 1.5 times the spans of the prisms 102; and the spans of the prisms 102 are equal to the lengths of bottom edges of the sides, close to the light guide plate substrate 101, of the main section of the prisms 102.

According to the light guide plate provided by an embodiment of the present disclosure, since the maximum widths of the lattice points 103 are less than 1.5 times the spans of the prisms 102, the lattice points 103 can be prevented from being too large, a fine-tuning range of a backlight source can be enlarged, and a uniform light effect of the lattice points 103 is guaranteed, and the uniformity of emergent light of a backlight module is improved.

FIGS. 1 to 4 are cross-sectional views of a plane where the main sections of the prisms 102 are located, and the figures take the main sections of the prisms 102 in triangles as an example for illustration. The main sections refer to sections perpendicular to extending directions of the prisms 102. In specific implementation, the main sections of the prisms 102 may also be in other shapes, such as trapezoids, polygons or arcs. The shapes of the main sections of the prisms 102 are not limited herein. In practical application, the prisms 102 may be in a long-strip shape, and the plurality of prisms 102 can be arranged side by side on the light emitting surface S1 of the light guide plate substrate 101. As shown in FIG. 1, the spans of the prisms 102 are equal to the lengths of bottom edges of the sides, close to the light guide plate substrate 101, of the main sections of the prisms 102 and may also be understood as a total width of the main sections, in contact with the surface of the light guide plate substrate 101, of the prisms 102. In FIG. 1, L represents the distance from an axis to an edge of each prism 102, so that the span of each prism 102 is 2L, and H represents the vertical distance between a highest point and a lowest point of each prism 102. If the main section of each prism 102 is triangular, a represents an included angle between a side edge and a bottom edge of the main section, and H=L*tan α.

The plurality of lattice points 103 are arranged on the lattice surface S2 of the light guide plate substrate 101. In specific implementation, the lattice points 103 may be arranged according to a certain rule or may be evenly dispersed on the surface of the light guide plate substrate 101, and distribution of the lattice points 103 is not limited herein. A light source 202 introduces light from a light incident side of the light guide plate substrate 101. Part of introduced light is directly emitted to the prisms 102 to be emitted, and part of the introduced light is emitted to the lattice surface S2 of the light guide plate substrate 101, and the lattice points 103 on the lattice surface S2 of the light guide plate substrate 101 have effects of reflecting and scattering light, and the like, so that reflected light forms scattered light distributed uniformly in various directions.

Since orthographic projections of the lattice points 103 on the light emitting surface S1 of the light guide plate substrate 101 and orthographic projections of the prisms 102 on the light emitting surface S1 of the light guide plate substrate 101 are overlapped, thus, light reflected at the lattice points 103 is more likely to emit from the prisms 102, the prisms 102 can converge the light, then light emitted from the light emitting surface S1 of the light guide plate substrate 101 can be converged in a certain area, and the intensity of the light emitted from the light emitting surface S1 of the light guide plate 101 can be increased.

In specific implementation, the lattice points 103 may be circular, oval or polygonal or be in other irregular shapes, which is not limited herein. When the lattice points 103 are circular, maximum widths of the lattice points 103 are diameters of the lattice points 103. When the lattice points 103 are oval, the maximum widths of the lattice points 103 are diameters of the lattice points in a long axis direction. When the lattice points 103 are polygonal or in irregular shapes, the distances between two furthest points on the edges of the lattice points 103 may be taken as the maximum widths of the lattice points 103, or the maximum widths of the lattice points 103 may be determined by other methods, which is not limited herein. In FIGS. 1 to 4, the lattice points 103 being circular are used as an example for illustration. In FIGS. 1 to 4, R represents the radius of each lattice point 103, and the maximum width of each lattice point 103 is 2R.

Therefore, the maximum widths of the lattice points 103 are less than 1.5 times the spans of the prisms 102, which can be expressed as 2R<3L, and L=H/tan α, so 2R<3H/tan α. If the areas of the lattice points 103 are too large, a fine-tuning range of a backlight source can be reduced, so that the maximum widths of the lattice points 103 are limited to a range less than 1.5 times the spans of the prisms 102, the sizes of the lattice points 103 can be prevented from being too large, the fine-tuning range of the backlight source is enlarged, the uniform light effect of the lattice points 103 is ensured, and the uniformity of emergent light of the backlight module is improved.

Optionally, according to the above light guide plate provided by the embodiment of the present disclosure, as shown in FIGS. 1 to 4, the maximum widths of the lattice points 103 may be greater than 0.5 time the spans of the prisms 102.

Taking structures shown in FIGS. 1 to 4 as an example, it can be expressed as 2R>L and L=H/tan α. Therefore, 2R>H/tan α, that is, the maximum width of each lattice point 103 should satisfy L<2R<3L. If the sizes of the lattice points 103 are too small, the proportion of light emitted from a single side edge of each prism 102 is high, that is, most of light reflected by the lattice points 103 exits from one side surface of each prism 102, obvious arrangement traces of the lattice points 103 can be observed on two sides of the prisms 102, so that rows and columns of the lattice points 103 on a light emitting side of a display panel are visible, and consequently, the uniformity of a display image of the display panel is poor. Therefore, by setting the maximum widths of the lattice points 103 to be 0.5 time larger than the spans of the prisms 102, light reflected by the lattice points 103 can emit from the two sides of the prisms 102, the light converging effect of the prisms 102 is improved, the uniformity of light emitted from the light guide plate is ensured, and thus the display effect is improved.

Optionally, according to the light guide plate provided by the embodiment of the present disclosure, referring to FIGS. 1 to 4, the prisms 102 may be triangular prisms, and the side lengths of the other two sides except the bottom edge of the main section of each triangular prism are equal.

The maximum width of each lattice point 103 satisfies the following relational expression:

H/tan α<D<3H/tan α, wherein

wherein, D represents the maximum width of each lattice point 103; H represents the height corresponding to the bottom edge in the main section of each triangular prism, and a represents the base angle in each main section.

As shown in FIGS. 1 to 4, L represents half of the side length of the bottom edge in the main section of each triangular prism, which satisfies H=L*tan α, the span of each triangular prism is 2L, and D represents the maximum width of each lattice point 103. Since the maximum widths of the lattice points 103 are generally greater than 0.5 time the spans of the prisms and less than 1.5 times the spans of the prisms 102, that is, L<D<3L, and in combination with H=L tan α, H/tan α<D<3H/tan α can be obtained. When the lattice points 103 are circular, D=2R may also be expressed as H/tan α<2R<3H/tan α. In specific implementation, the maximum widths of the lattice points 103 and various parameters in the triangular prisms can be determined according to the relational expression.

In summary, the maximum widths of the lattice points 103 are limited to be 0.5 time greater than the spans of the prisms 102 and less than 1.5 times the spans of the prisms 102, the sizes of the lattice points 103 can be prevented from being too large or too small, good matching of the sizes of the prisms 102 and the lattice points 103 can be ensured, and the problem of poor optical pictures caused by poor size matching between the prisms 102 and the lattice points 103 is eliminated.

In specific implementation, the above prisms 102 and lattice points 103 may be manufactured with the light guide plate substrate 101 through an integral molding process, and the prisms 102 and the lattice points 103 may also be manufactured on the light guide plate substrate 101 through a corresponding process, which is not limited herein.

Optionally, according to the above light guide plate provided by the embodiment of the present disclosure, the prisms 102 and the lattice points 103 in the light guide plate may be implemented as follows.

### Embodiment 1

Referring to FIG. 1, the prisms 102 protrude from a surface on the light emitting surface S1 of the light guide plate substrate 101; and

the lattice points 103 protrude from a surface on the lattice surface S2 of the light guide plate substrate 101.

The prisms 102 and the lattice points 103 protrude from a surface of the light guide plate substrate 101. In a manufacturing process, a layer of prisms 102 may be directly manufactured on the surface of the light guide plate substrate 101, a layer of lattice points 103 may be manufactured on the other surface of the light guide plate substrate 101, the manufacturing process is simple, and the cost is low.

### Embodiment 2

As shown in FIG. 2, the prisms 102 protrude from a surface on the light emitting surface S1 of the light guide plate substrate 101; and

the lattice points 103 are recessed on a surface on the lattice surface S2 of the light guide plate substrate 101.

By recessing the lattice points 103 on the surface of the light guide plate substrate 101, the thickness of the light guide plate can be reduced, and further the thickness of a backlight module is reduced, thus being beneficial to the lightening and thinning design of a display device. In specific implementation, a plurality of pits are formed in the surface of the flat light guide plate substrate 101, so that a plurality of lattice points 103 are formed, the light guide plate substrate 101 with the pits can also be directly formed by an integral molding process, and the manufacturing process is simple and feasible.

### Embodiment 3

As shown in FIG. 3, the prisms 102 are recessed on the surface on the light emitting surface S1 of the light guide plate substrate 101; and

the lattice points 103 protrude from the surface on the lattice surface S2 of the light guide plate substrate 101.

By recessing the prisms 102 on the surface of the light guide plate substrate 101, the thickness of the light guide plate can be reduced, and further the thickness of the backlight module is reduced, thus being beneficial to the lightening and thinning design of the display device. In specific implementation, a plurality of groove structures matched with the prisms 102 in shape may be formed on the surface of the flat light guide plate substrate 101, the groove structures are filled with a material of the prisms 102, or the light guide plate substrate 101 with the groove structures may be formed through an integral molding process, and the groove structures are filled with the material of the prisms 102, so that a structure shown in FIG. 3 is formed, and the manufacturing process is simple and feasible.

### Embodiment 4

As shown in FIG. 4, the prisms 102 are recessed on the surface on the light emitting surface S1 of the light guide plate substrate 101; and

the lattice points 103 are recessed on the surface on the lattice surface S2 of the light guide plate substrate 101.

By recessing the prisms 102 and the lattice points 103 on the surface of the light guide plate substrate 101, the thickness of the light guide plate can be reduced maximumly, and further the thickness of the backlight module is reduced, thus being beneficial to the lightening and thinning design of the display device. In specific implementation, a plurality of groove structures may be formed in one side of the flat light guide plate substrate 101, a plurality of pits may be formed in the other side of the flat light guide plate substrate 101, and the groove structures are filled with a material of the prisms 102, so that a structure shown in FIG. 4 is formed, or the light guide plate substrate 101 with the groove structures on one side and the pits on the other side may be directly formed through an integral molding process, and the groove structures are filled with the material of the prisms 102, so that the structure shown in FIG. 4 is formed, and the manufacturing process is simple and feasible.

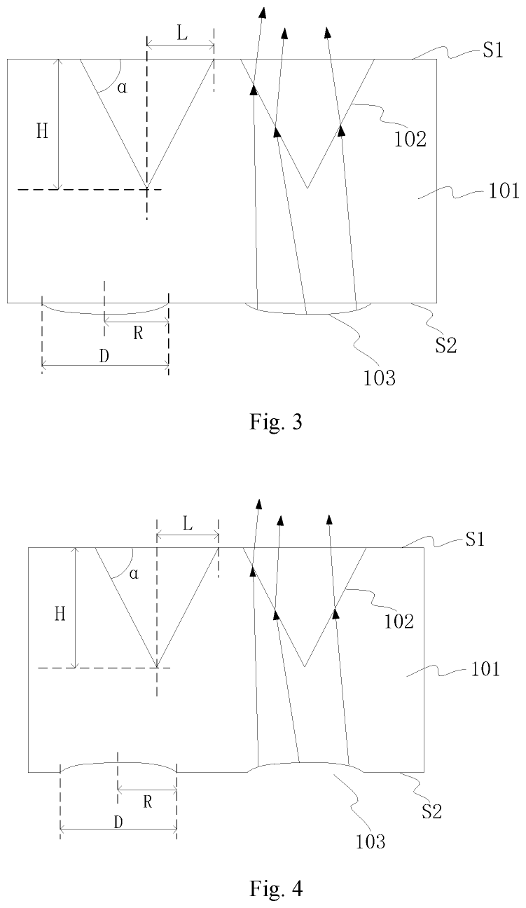

In specific implementation, according to the above light guide plate provided by the embodiment of the present disclosure, as shown in FIG. 5, the plurality of lattice points 103 may be arranged in an array;

each prism 102 may correspond to a row or a column of the lattice points 103.

FIG. 5 shows a top view of the light guide plate viewed from the side of the lattice surface S2 of the light guide plate. Since the prisms 102 are not formed on the lattice surface S2, the prisms 102 are shown by dotted boxes in the figure. FIG. 5, takes the prisms 102 corresponding to a row of the lattice points 103 as an example. In practical application, the prisms 102 may also correspond to a row of the lattice points 103. In this way, the lattice points 103 and the prisms 102 are distributed more uniformly, and the uniformity of light emitted from the light emitting surface S1 of the light guide plate is good. In addition, the lattice points 103 and the prisms 102 may be distributed and correspond in other modes. For example, in FIG. 5, one lattice point 103 may be inserted between two adjacent lattice points 103, which is just an example herein, and distribution and corresponding relationship between the lattice points 103 and the prisms 102 are not limited.

Moreover, in order to increase a light utilization rate, a reflection film may be plated or a reflection plate may be arranged on the sides, away from the prisms 102, of the lattice points 103, so that light leaking from the lattice points 103 is reflected back into the light guide plate substrate 101, the reflection amount of light on the lattice surface S2 is increased, more light is emitted from the light emitting surface, and the light utilization rate is increased.

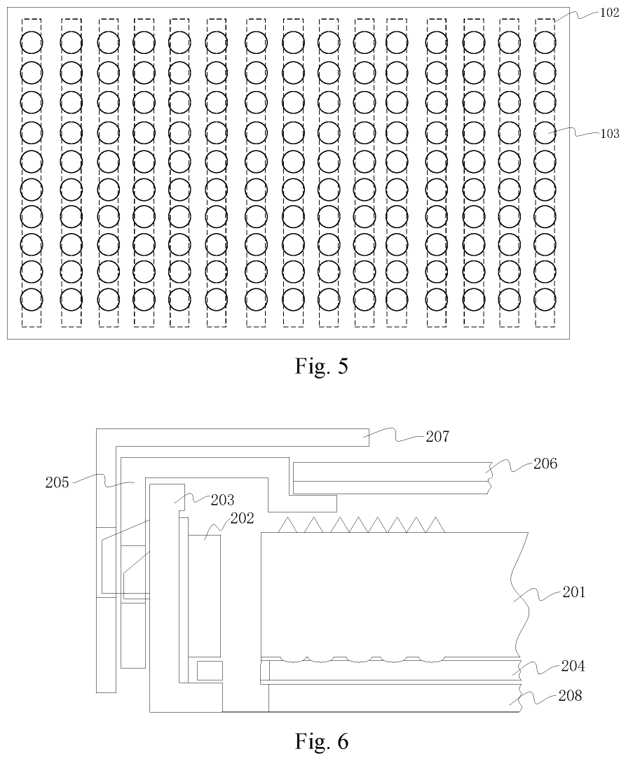

Based on the same inventive concept, an embodiment of the present disclosure provides a backlight module. As shown in FIG. 6, the backlight module includes the above light guide plate 201. Since the principle for solving the problem of the backlight module is similar to that of the above light guide plate, implementation of the backlight module can refer to the implementation of the above light guide plate, and repeated details will not be described.

Since the lattice points 103 in the light guide plate 201 provided by the embodiment of the present disclosure are not too large or too small, the uniformity of emergent light of the backlight module including the light guide plate 201 is good, and a display effect of the display panel 206 is ensured.

Optionally, the backlight module provided by the embodiment of the present disclosure, referring to FIG. 6, may further includes a light source 202 on a side surface of the light guide plate 201, and a reflection plate 204 located on the lattice surface S2 of the light guide plate 201.

The light source 202 is arranged on the side surface of the light guide plate 201, and light emitted from the light source 202 is emitted from a light emitting surface of the light guide plate 201 through processes such as reflection and scattering of the light guide plate 201, so that a point light source or a line light source is converted into a surface light source required for a display panel, so as to ensure an effect that the display panel displays pictures normally. By arranging the reflection plate 204 on the side of the lattice surface S2 of the light guide plate 201, light leaking from the lattice points 103 can be reflected back into the light guide plate substrate 101, that is, the reflection amount of light on the lattice surface S2 is increased, thus, more light is emitted from the light emitting surface, and the light utilization rate is increased.

Optionally, the backlight module provided by the embodiment of the present disclosure, referring to FIG. 6, may further include a back plate frame 205 located on the side of the light emitting surface S1 of the light guide plate 201, and a back plate 208 located on the side of the lattice surface S2 of the light guide plate 201; and

an orthographic projection of an edge, on the side of the light emitting surface S1 of the light guide plate 201, of the back plate frame 205 on the light emitting surface S1 of the light guide plate 201 and the orthographic projections of the prisms 102, located on the light emitting surface S1 of the light guide plate 201, on the light emitting surface S1 of the light guide plate 201 are overlapped. That is, the back plate frame 205 will shield the prisms 102 located at the edges, and a light emitting effect at the edges is better balanced.

Optionally, in the backlight module provided by the embodiment of the present disclosure, referring to FIG. 6, orthographic projections of the lattice points 103 of the lattice surface S2 on the light emitting surface S1 of the light guide plate 201 and orthographic projection of the edge, on the light emitting surface S1 of the light guide plate 201, of the back plate frame 205 on the light emitting surface S1 of the light guide plate 201 are overlapped. That is, the back plate frame 205 shields the lattice points 103 located at the edges, so that a light emitting effect at the edges is better balanced.

Further, in the backlight module provided by the embodiment of the present disclosure, referring to FIG. 6, orthographic projections of at least two rows of the lattice points 103 on the lattice surface S2 on the light emitting surface S1 of the light guide plate 201 and the orthographic projection of the edge, on the light emitting surface S1 of the light guide plate 201, of the back plate frame 205 on the light emitting surface S1 of the light guide plate 201 are overlapped. That is, the back plate frame 205 shields the lattice points 103 located at the edges, so that a light emitting effect at the edges is better balanced.

In specific implementation, the light source 202 may include a light bar composed of a plurality of light emitting diodes (LEDs), and the light source 202 is connected to a light source back plate 203. The display panel 206 is fixedly connected to the backlight module through the back plate frame 205 and a display module upper frame 207.

Based on the same inventive concept, an embodiment of the present disclosure provides a display device. As shown in FIG. 6, the display device includes the above backlight module, and may further include a display panel 206 located on the side of the light emitting surface S1 of the light guide plate. The display device may be applied to any product or component with a display function, such as a mobile phone, a tablet computer, a television, a display, a notebook computer, a digital photo frame and a navigator. Since the principle of the display device to solve the problem is similar to that of the above backlight module, the implementation of the display device may refer to the implementation of the above backlight module, and the repeated details will not be described.

According to the light guide plate, the backlight module and the display device provided by the embodiments of the present disclosure, since the maximum widths of the lattice points are less than 1.5 times the spans of the prisms, therefore, the sizes of the lattice points can be prevented from being too large, the light source fine-tuning range of the backlight source is enlarged, the uniform light effect of the lattice points is ensured, and the uniformity of emergent light of the backlight module is improved. In addition, the maximum widths of the lattice points may be greater than 0.5 time the spans of the prisms, so that the lattice points are prevented from being too small, the effect that light reflected by the lattice points is emitted from the two sides of the prisms is ensured, and the uniformity of light emitted from the light guide plate is improved.

Obviously, those skilled in the art can make various modifications and variations to the present disclosure without departing from the spirit and scope of the present disclosure. In this way, if these modifications and variations of the present disclosure fall within the scope of the claims and the equivalent technologies thereof, the present disclosure also intends to include these modifications and variations.

1. A light guide plate, comprising:
a light guide plate substrate provided with a light emitting surface and a lattice surface arranged oppositely;
a plurality of prisms located on the light emitting surface; and
a plurality of lattice points located on the lattice surface, wherein
orthographic projections of the lattice points on the light emitting surface and an orthographic projection of at least one of the prisms on the light emitting surface are overlapped; a maximum width of any one of the lattice points is less than 1.5 times a span of any two adjacent ones of the prisms; and the span is equal to a length of a bottom edge close to the light guide plate substrate, of a main section of any one of the prisms.

2. The light guide plate according to claim 1, wherein the maximum width of any one of the lattice points are greater than 0.5 time the span.

3. The light guide plate according to claim 2, wherein the prisms are triangular prisms, and lengths of other two sides of the triangular prisms except bottom edges are equal to each other;
the maximum width satisfies following relational expression:
H/tan α<D<3H/tan α, wherein
D represents the maximum width; H represents a height corresponding to the bottom edge, and α represents a base angle in the main section.

4. The light guide plate according to claim 1, wherein the prisms protrude from a surface, on a side of the light emitting surface, of the light guide plate substrate; and
the lattice points protrude from a surface, on a side of the lattice surface, of the light guide plate substrate.

5. The light guide plate according to claim 1, wherein the prisms protrude from a surface, on a side of the light emitting surface, of the light guide plate substrate; and
the lattice points are recessed on a surface, on a side of the lattice surface, of the light guide plate substrate.

6. The light guide plate according to claim 1, wherein the prisms are recessed on a surface, on a side of the light emitting surface, of the light guide plate substrate; and
the lattice points protrude from a surface, on a side of the lattice surface, of the light guide plate substrate.

7. The light guide plate according to claim 1, wherein the prisms are recessed on a surface, on a side of the light emitting surface, of the light guide plate substrate; and
the lattice points are recessed on a surface, on a side of the lattice surface side, of the light guide plate substrate.

8. The light guide plate according to claim 1, wherein
the plurality of lattice points are arranged in an array; and
any one of the prisms corresponds to a row or a column of the lattice points.

9. The light guide plate according to claim 8, wherein the lattice points are circular, oval or polygonal.

10. A backlight module, comprising: the light guide plate according to claim 1.

11. The backlight module according to claim 10, further comprising: a light source located on a side surface of the light guide plate, and a reflection plate located on a side of the lattice surface of the light guide plate.

12. The backlight module according to claim 11, further comprising: a back plate frame located on a side of the light emitting surface of the light guide plate, and a back plate located on the side of the lattice surface of the light guide plate; and
an orthographic projection of an edge, on the side of the light emitting surface of the light guide plate, of the back plate frame on the light emitting surface of the light guide plate overlaps with orthographic projections of the prisms located on the light emitting surface of the light guide plate on the light emitting surface of the light guide plate.

13. The backlight module according to claim 12, wherein orthographic projections of the lattice points of the lattice surface on the light emitting surface of the light guide plate overlap with the orthographic projection of the edge, on the side of the light emitting surface of the light guide plate, of the back plate frame on the light emitting surface of the light guide plate.

14. The backlight module according to claim 13, wherein orthographic projections of at least two rows of lattice points located on the lattice surface on the light emitting surface of the light guide plate overlap with the orthographic projection of the edge, on the side of the light emitting surface of the light guide plate, of the back plate frame on the light emitting surface of the light guide plate are overlapped.

15. A display device, comprising: the backlight module according claim 10.

16. The display device according to claim 15, further comprising: a display panel located on the side of the light emitting surface of the light guide plate.
